(19) United States
(12) Patent Application Publication
(10) Pub. No.: US 2003/0171985 A1
(43) Pub. Date: Sep. 11, 2003

(54) Multi mode pay per use or free use apparatus

(76) Inventors: Jay Prabhu, Jersey city, NJ (US); Meenakshi Prasad, Ringwood, NJ (US)

Correspondence Address: Mr. Walter J. Tencza Jr., Suite 3, 10 Station Place, Metuchen, NJ, 08840, US

(21) Appl. No.: 10/092,856

(22) Filed: Mar. 7, 2002

(51) Int. Cl. G06F 17/60

(52) U.S. Cl. 705/14

(57) ABSTRACT

The present invention provides an internet and telecommunication apparatus incorporating computer software for providing an advertising, entertainment, communication and personal utilities center The apparatus in at least one embodiment has unique features such as sales, tickets, tickertape and discount coupon generation. The apparatus can provide for Internet regular and videophone capability, office connectivity, multicolor printing, email and fax. Full functionality for postage, greeting cards, tickets for games, movies, lottery, utilities and municipal ticket payments, garage payments, or other items has been enabled. The apparatus can be a media center for television, music, and gaming via Internet or customer selectable with DVD/CD burner for custom storage. It can function as a full capability replacement device for telephone, Internet, media, advertising, television and printing machines currently in use. The present invention also includes a method which provides one or more of the above various functions.

### FIELD OF THE INVENTION

This invention concerns publicly available telecommunications or internet related devices.

### BACKGROUND OF THE INVENTION

Telecommunications or internet related devices which are provided in public places in the prior art, typically are one dimensional in the features that they provide.

In the prior art there is no public use, pay per use, or free use Internet enabled apparatus that gives the customer a choice of carriers. Most prior art devices are proprietary and direct all connections to their Internet Service Provider/site/content provider. Furthermore, the prior art machines did not provide location driven content. In the prior art it is a one-size-fits-all business model.

In the prior art, after you purchase a product, a competing product will generate a coupon for their product on your next purchase. This prior art method may be satisfactory for groceries but it may not be satisfactory for electronics and other house hold items. The standard directory service that malls provide generates a list of stores and where they are in the mall. Some prior art systems have a look up table for items and items on sale.

Prior art Internet kiosks exist, however these are not location centric and do not provide user selectable Internet content providers. Further the prior art internet kiosks do not provide facilities for regular, cable and pay per view or use TV other than web TV. Gaming is limited to on site games or Internet games. The prior art internet kiosks do not provide a full scale banking facility, which includes cash withdrawals and transfers.

The advertisements on most prior art Internet machines are displayed when one is accessing the Internet otherwise they show a blank screen or an invitation to use the machines.

In the prior art when one uses a phone or a videophone one has a choice of a single carrier or to use one's calling card to select the carrier. The price on the card in the prior art is pre fixed at the time of purchase. Again your choice is not market driven at the time of placing the call but is market driven at time of purchasing the card.

In the prior art in order to pay a parking violation's ticket one may have to go to a municipal court, wait in line to pay or to mail in the parking violation's ticket fee.

In prior art devices in some locations one could pay for parking in a mall or an airport itself, however you need to go to a specific machine and the machine allows you to pay only for a particular parking lot or operator.

### SUMMARY OF THE INVENTION

The present invention in one or more embodiments provides an internet and communication apparatus incorporating computer software for providing an advertising, entertainment, communication and personal utilities center. The apparatus in at least one embodiment has unique features such as sales, tickets, tickertape and discount coupon generation. It provides for Internet regular and videophone capability, office connectivity, multicolor printing, email and fax. Full functionality for postage, greeting cards, tickets for games, movies, lottery, utilities and municipal ticket payments, garage payments, etc. has been incorporated. It is a media center for television, music, and gaming via Internet or customer selectable with DVD/CD (digital video disc/compact disc) burner for custom storage. It can function as a full capability replacement device for telephone, Internet, media, advertising, television and printing machines currently in use.

The present invention provides in one or more embodiments an apparatus which provides one or more of the following:

A) General Features:

A1) A user selectable internet enabled public access pay per use computer;

A2) A location, time, date, event centric advertising tool;

A3) A shopper centric sale generator; and A Point-of-Sale; advertising/discount coupon generator; a

A4) A location centric tickertape generator for stock exchanges, game scores, racing etc;

The present invention also provides in one or more embodiments the following:

B) Entertainment Features:

B1) A pay-per-use and pay-per-view television;

B2) A gaming tool for

a) resident games;

b) A game enabler for a user's own game cartridges; and

c) Internet games

B3) A CD/DVD (compact disc/digital video disc) burner for customized web enabled and downloaded music, and video recording.

The present invention also provides in one or more embodiments the following:

C) Communication features:

C1) A user selectable public access pay per use telephone, video phone, phone card generator and cell phone validator with a user selectable carrier;

C2) A portal for office connectivity to hand held devices and notebooks;

C3) Multicolor printing capability to enable instant hardcopy generation;

C4) Email capability; and

C5) Fax capability.

The present invention also provides in one or more embodiments the following:

D) Personal Utility features:

D1) A public access, carrier independent postage generator;

D2) A custom greeting card generator;

D3) A ticket generator for games, plays, airlines etc;

D4) A location centric lottery ticket generator with customer driven selection storage and recall for replay;

D5) banking device with cash dispenser and banking chores;

D6) A utilities, and municipal tickets payment device; and

D7) A location centric parking garage payment device (for malls, airports, stadiums etc.);

### BRIEF DESCRIPTION OF THE DRAWINGS

FIG. 1 shows block diagram of an apparatus in accordance with a first embodiment of the present invention;

FIG. 2 shows a flow chart of a first method which can be executed by the apparatus of FIG. 1;

FIG. 3 shows a flow chart of a main control method which can be executed by the apparatus of FIG. 1;

FIG. 4 shows a flow chart of an internet method which can be executed by the apparatus of FIG. 1;

FIG. 5 shows a flow chart of a advertising method which can be executed by the apparatus of FIG. 1;

FIG. 6 shows a flow chart of a shopping method, which can be executed by the apparatus of FIG. 1;

FIG. 7 shows a flow chart of a ticker tape method, which can be executed by the apparatus of FIG. 1;

FIG. 8 shows a flow chart of a select television method, which can be executed by the apparatus of FIG. 1;

FIG. 9 shows a flow chart of a selected gaming method, which can be executed by apparatus of FIG. 1;

FIG. 10 shows a flow chart of a selected CD/DVD recording method, which can be executed by apparatus of FIG. 1;

FIG. 11 shows a flow chart of a selected telecommunications method, which can be executed by apparatus of FIG. 1;

FIG. 12 shows a flow chart of a selected laptop, PDA and similar device connectivity method, which can be executed by apparatus of FIG. 1;

FIG. 13 shows a flow chart of a select mailer method, which can be executed by the apparatus of FIG. 1;

FIG. 14 shows a flow chart of a selected ticketing method, which can be executed by the apparatus of FIG. 1;

FIG. 15 shows a flow chart of a select lottery method, which can be executed by the apparatus of FIG. 1;

FIG. 16 shows a flow chart of a selected banking method, which can be executed by the apparatus of FIG. 1.

FIG. 17 shows a flow chart of a selected Utilities method, which can be executed by the apparatus of FIG. 1; and

FIG. 18 shows a flow chart of a selected parking method, which can be executed by the apparatus of FIG. 1.

### DETAILED DESCRIPTION OF THE DRAWINGS

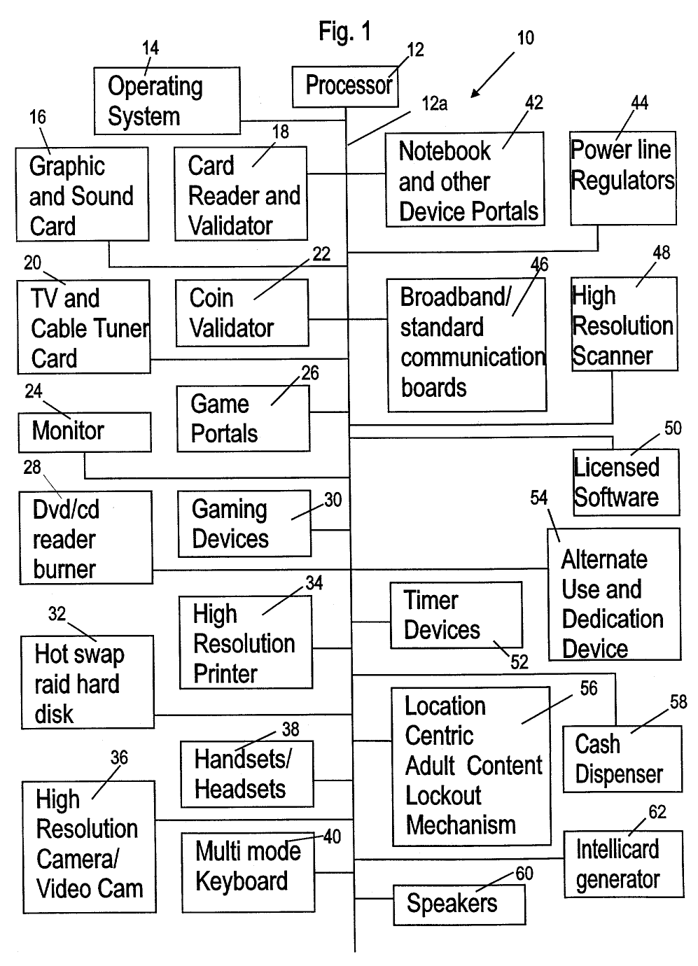

FIG. 1 shows a block diagram of an apparatus 10 in accordance with a first embodiment of the present invention. The apparatus 10 includes processor 12 and a plurality of components. The components include operating system 14, graphic and sound card 16, card reader and validator 18, TV (television) and cable tuner card 20, coin validator 22, monitor 24, game portals 26, DVD (Digital Video Disc) 28, gaming devices 30, hot swap raid hard disk 32, high resolution printer 34, high resolution camera/video Cam 36, handsets/headsets 38, multi-mode keyboard 40, notebook and other device portals 42, power line regulators 44, broadband/standard communication boards 46, high resolution scanner 48, licensed software 50, timer devices 52, alternate use and dedication device 54, location centric adult content lockout mechanism 56, cash dispenser 58, speakers 60, intellicard generator 62. The apparatus 10 also includes a bus 12a through which all of the components 14-62 are electrically connected to the processor 12. The components 14-62 may be standardized universally accepted components. The components 14-62 may be connected by hardwired electrical connections and/or wireless electrical connections or in any other known manner.

The processor 12 may be comprised of a high speed vendor independent computer processor. The processor 12 may be comprised of any typical computer processor or a plurality of computer processors. The bus 12a may be comprised of a high speed motherboard bus. The operating system 14 may be comprised of a conventional operating system known in the art, such as WINDOWS (TRADEMARKED). The operating system 14 may be stored in computer memory which may be part of the processor 12. The operating system 14 may be run by processor 12.

The graphic and sound card 16 may be a high resolution graphic and sound card such as a SOUND BLASTER (TRADEMARKED) stereo component.

The card reader and validator 18 may be a MAGTEK (TRADEMARKED) smart card reader.

The TV and cable tuner card 20 may be a RADEON (TRADEMARKED) PRO TV (TRADEMARK) tuner card.

The coin validator 22 may be a NRI (TRADEMARKED) electronic coin validator System G-13.600.

The monitor 24 may be a typical computer monitor, a touch screen video monitor, a monitor with direct video feeds, or any other type of monitor.

The game portal 26 may be a MICROSOFT (TRADEMARKED) SIDEWINDER (TRADEMARKED) GAME PRO (TRADEMARKED) for use in playing games, such as video or computer games.

The DVD/CD reader burner 28 may be a TOSHIBA (TRADEMARKED) SD-m1402 12xDVD 40XCDR EIDE w/decoder.

The hot swap raid hard disk 32 may be a WESTERN DIGITAL (TRADEMARKED) model Caviar 30 GigaBytes EIDE/Ultra ATA 100. These acronyms are industry descriptors and the applicant does not know what the acronyms stand for, if anything.

The high resolution printer 34 or 48 may be a BROTHER (TRADEMARKED) MFC 3100C 8/12 PPM 14400 PL print/copy/scan/fax machine. The initials “MFC and “PPM” and “PL” are just part of the model number and the applicant doesn't known what they stand for, if anything.

The high resolution camera/video cam 36 may be a LOGITECH (TRADEMARKED) QuickCam Express DV-USB Pro 3000.

The handsets/headsets 38 can be used to listen to sound from the processor 12 without another individual hearing.

The multi-mode keyboard 40 can be used to enter data into the processor 12 as known.

The notebook and other device portals 42 may be a typical portal for a notebook computer known in the art.

The licensed software 50 may run on an external device.

The cash dispenser 58 may be a FUJITSU (TRADEMARKED) 7400.

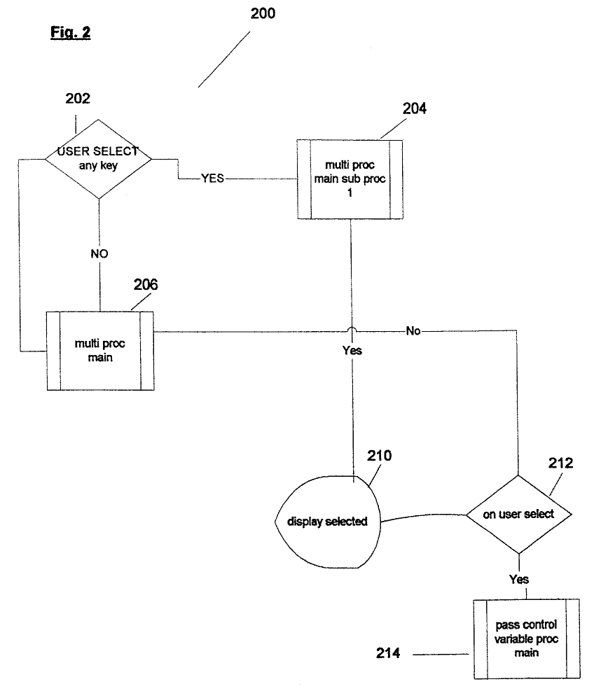

FIG. 2 shows a flow chart 200 of a method which can be executed by the apparatus 10 of FIG. 1. If a user of the apparatus 10 has hit or selected any key on the multi-mode keyboard 40 in FIG. 1, at step 202 of FIG. 2, then the processor 12 causes the multiple process main subroutine to be executed at step 204. In Step 204, the location specific data such as restrictions on internet site access, stored in the memory of the processor 12 is accessed and displayed on the monitor 24 at step 210. At step 212 if the user presses any key on the keyboard 40 or clicks the mouse or touch screen, control is passed to step 214 of FIG. 2.

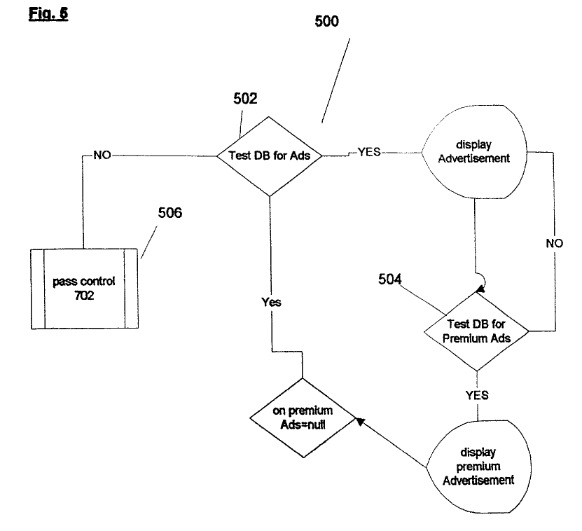

If the user has not selected any key on the keyboard 40 at step 202 or 212 then step 206 is executed. Step 206 passes control to step 502 in FIG. 5.

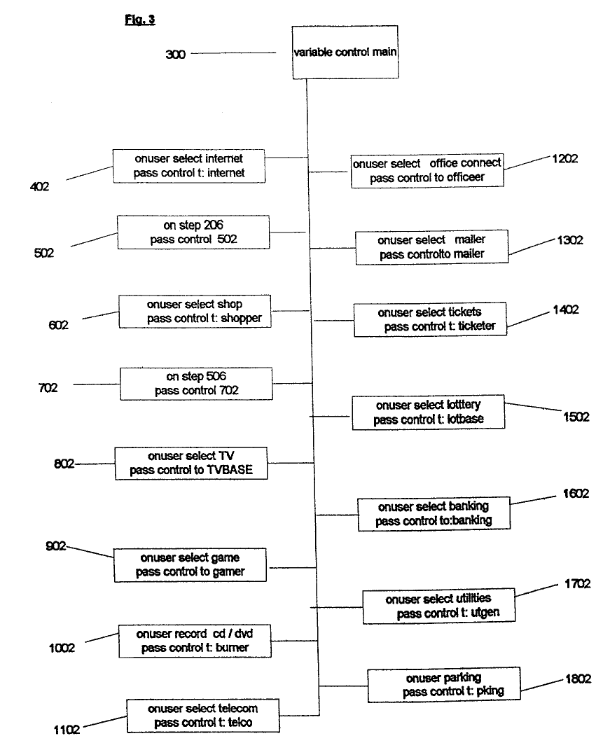

FIG. 3 shows what occurs after the processor 12 begins executing the main control method at step 214. FIG. 3 shows a flow chart 300 of the main control method which can be executed by the apparatus 10 of FIG. 1. The main control method allows a user to select one of various options which will determine what the processor 12 does next. The flow chart 300 shows an internet method option at step 402, a step 502 which is executed after the step 206 is executed in FIG. 2, a shop option at step 602, a step 702 which is executed after step 506 in FIG. 5, a select television option at step 802, a select game option at step 902, a select CD/DVD burner option at step 1002, a select telecommunications carrier option at step 1102, a select office connectivity option at step 1202, a select mailer option at step 1302, a select tickets option at step 1402, a select lottery option at step 1502, a select banking option at step 1602, a select utilities option at step 1702, and a select parking option at step 1802.

The user can execute one of the various steps 402, 502, 602, 702, 802, 902, 1002, 1102, 1202, 1302, 1402, 1502, 1602, 1702, and 1802 by typing in the appropriate option at the keyboard 40 or using a computer mouse to click on an appropriate option on the monitor 24, or if the monitor 24 is a touch screen, by touching the appropriate option on the monitor 24.

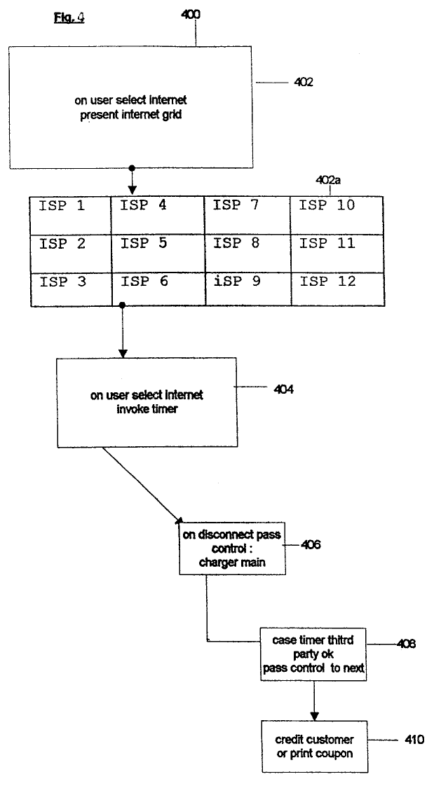

FIG. 4 shows a flow chart 400 of an internet method which can be executed by the apparatus 10 of FIG. 1. At step 402,a grid 402a of potential internet service providers is provided by the processor 12 and displayed on the monitor 24. The grid 402a is a sample of a possible grid. “ISP 1” through “ISP 12” may be the names of actual internet service providers. For example “ISP 1” may be America Online (trademarked).

At step 404, the processor 12 starts a timer, which disconnects the internet service if time has run out if the user pays by cash (through for example validators 18 or 22) and passes control to the charger, i.e. to step 406. Step 406 charges a card/debit/prepaid card if a user pays by card/debit/prepaid card (through for example card reader and validator 18). At step 408, the processor 12 determines if the internet service provider has a promotion for using their service. This can be determined by information which may be available through the internet, such as through communication board 46 which may be connected to an internet or generally to a telecommunication line. If a promotion exists control passes to step 410. In step 410, the processor 12 charges the service provider for the user's time and if the user paid by cash (through validators 18 or 22) a coupon for future use is issued to the user by being printed, for example, via printer 34 of FIG. 1. If the payment is made through a credit/debit/prepaid card, a credit is issued to the same. The card/debit/prepaid card information received, for example by card reader and validator 18 may be supplied to a card/debit/prepaid card company via communication boards 46 and communication line to which boards 46 are connected.

FIG. 5 shows a flow chart 500 of what happens after step 206 in FIG. 2. At step 502 the processor 12 searches the database of advertisements, for example in memory of processor 12, tests the time clock for current time and if the advertisement is to be displayed, it displays the advertisements on monitor 24. Step 504 is also executed by processor 12 concurrently. Step 504 causes the processor 12 to look at a database of premium advertisements which may be located in memory of processor 12 and interrupts the process of step 502 to display premium advertisements on monitor 24. After displaying a series of advertisements, control passes back to step 502. After displaying a series of advertisements, step 502 passes control to step 506. At step 506 processor 12 stops displaying advertisements on monitor 24 and passes control to step 702 the location centric ticker tape of news, game scores, stock news, etc are displayed.

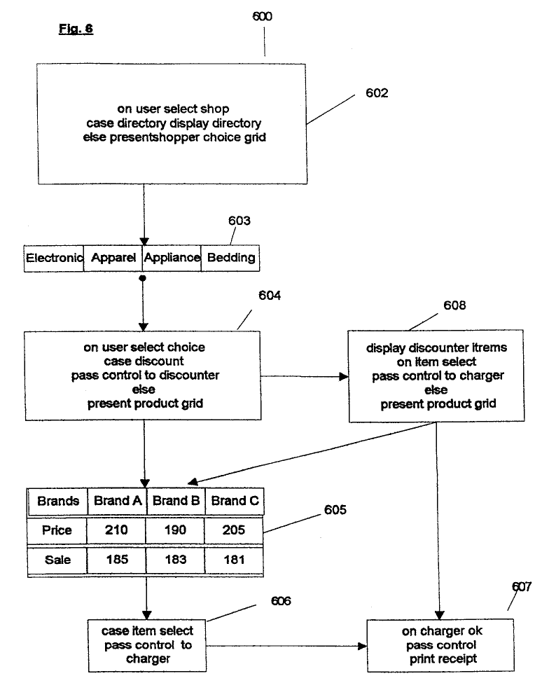

FIG. 6 shows a flow chart 600 of a selected shopping method which can be executed by the apparatus 10 of FIG. 1. At step 602 if the user selects the directory option on the monitor 24, the processor 12 will look up a location specific database in the memory of the processor 12, display a directory of stores at the location of the apparatus 10, and a map, on the monitor 24. If the user does not select the directory option, a grid 603 of merchandise classification carried at the general location of apparatus 10 (such as at the mall where apparatus 10 is located) is displayed on monitor 24. (an example is shown in FIG. 6). If the user selects any choice, by for example an entry using keyboard 40 (such as by typing in “Electronic” or “1” in the example of the grid 603), the processor 12 next executes step 604. At step 604, the processor 12 will look up a location specific database in the memory of the processor 12 for any discounted/sale items of that classification. If a location specific database is present the processor 12 will next execute step 608. The processor 12 at step 608 will display any discounted items on the monitor 24. If a user selects any item in step 608, the processor 12 next executes step 607. At step 607, the processor 12 charges the users for merchandise purchased and prints a receipt on printer 34. The customer can then take this receipt to the store, pick up the item, and leave. There is thus no need to stand in line for sales help, or to stand in a line to pay.

If at step 604, no discounts are available, the processor 12 at step 604 will look up a database in the memory of the processor 12 and present products, their prices, and stores where the particular product is available in a grid 605 on monitor 24. (Grid 605 is an example) If a user selects an item by touching monitor 24 at the appropriate location for example, the processor 12 next executes step 606. The processor 12 at step 606 confirms the order and if the user provides an entry into keyboard 40 to “ok” or affirm the purchase, control passes to step 607. The processor, at step 607, charges the user for merchandise purchased by charging a credit/debit/prepaid card/debit/prepaid card via a communications line connected to communication boards 46 for example and prints a receipt via printer 34. The customer can then take this receipt to the store, pick up the item or product, and leave.

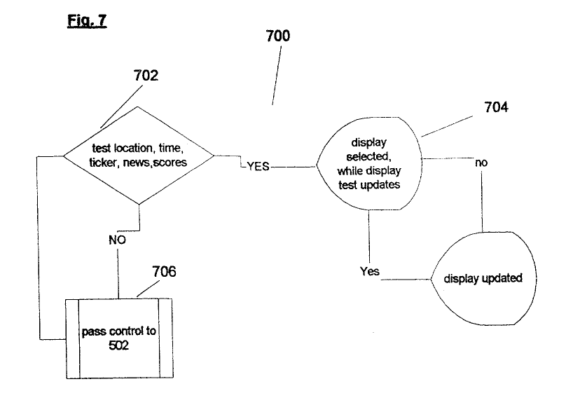

FIG. 7 shows a flow chart 700 of what happens after step 506 in FIG. 5. At step 702 the processor 12 searches the database, which may be in memory of processor 12, for information about the location of the processor 12, tests the time clock for current time and if the ticker tape of news, game scores, stock news, etc is to be displayed on the monitor 24, it displays the tickertape on the monitor 24. Step 704 is also executed by processor 12 concurrently. Step 704 causes the processor 12 to look at a database of late breaking news, stock and game score etc. which may be downloaded from the internet into memory of the processor 12, and interrupts the process of step 702 to display such announcements. After displaying a series of such announcements, control passes back to step 702. After displaying a series of advertisements, step 702 passes control to step 706. At step 706 processor 12 stops displaying tickertape information and passes control to step 702.

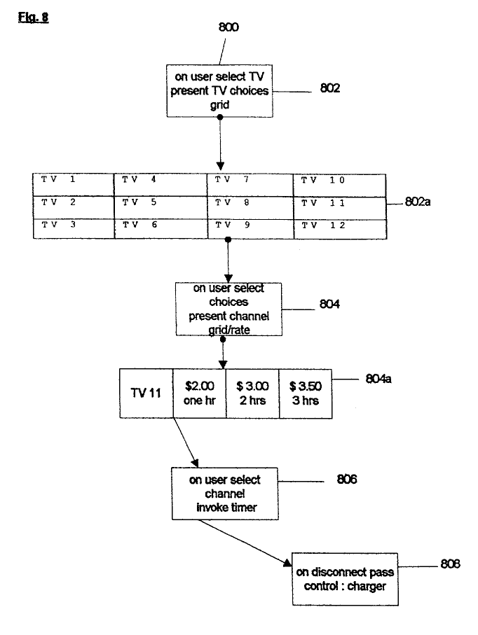

FIG. 8 shows a flow chart 800 of a select television method which can be executed by the apparatus 10 of FIG. 1. At step 802, the user has selected the television option and the processor 12 causes the monitor 24 to display a plurality of TV choices in a grid 802a.

Next at step 804 the user selects an option via for example keyboard 40. A grid, such as grid 804a will be displayed. For example, if the user selects “TV 11” on the grid 802a then the grid 804a concerning the price rates for watching “TV 11” are displayed. The user may then select an amount of time and a corresponding price rate such as $2.00 for one hr. in grid 804. If the user selects a television channel, the processor 12 may start a timer at step 806 and request that an amount be inserted at the cash acceptance slot 22 FIG. 1 or that a credit/debit/prepaid card be inserted into card validator 18 in FIG. 1. When the timer stops at step 808 the processor 12 may prevent the user from further viewing the particular television channel.

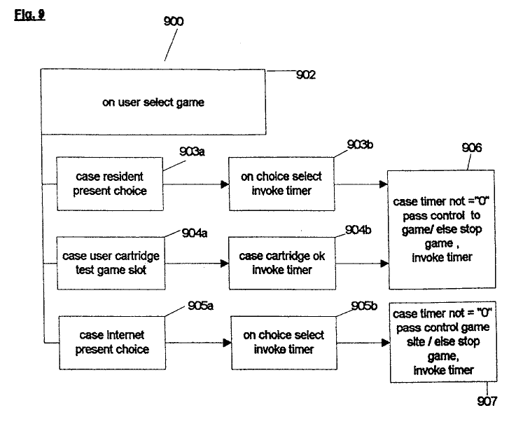

FIG. 9 shows a flow chart 900 of a selected gaming method which can be executed by apparatus 10 of FIG. 1. At step 902, the user has selected a gaming option, through for example keyboard 40. The processor 12 presents an option at step 902 of available gaming devices/techniques available by displaying these on the monitor 24 shown in Table B2-1 and Table B2-1a, B2-1b and B2-1c which follow:

TABLE B2-1

| | | |
|---|---|---|
| Resident | Cartridge | Internet |
| Games | Games | Games |

TABLE B2-1a
Resident Games

| | | |
|---|---|---|
| Game 1 | Game 2 | Game 3 |
| Game 4 | Game 5 | |

TABLE B2-1b
Cartridge Games
insert your cartridge in the red game slot

TABLE B2-1c
Internet Games

| | | | |
|---|---|---|---|
| game a | game b | game c | game d |

If the user selects the resident games option then step 903a of FIG. 9 is executed. At step 903a, the processor 12 looks up a database of resident games on the memory of the processor 12 and the processor 12 presents a choice on monitor 24 at step 903b. Also at step 903b, the processor 12 invokes a timer and sets the timer to zero. The processor 12 uses the timer to prompt the user to pay by a message placed on the monitor 24. On payment, the processor 12 resets the timer to a predefined duration and the processor 12 next executes step 906 shown in FIG. 9. At step 906, the processor 12 checks the status of the timer and as long as the timer is not zero the processor 12 passes control to the game computer software running on the processor 12, otherwise the processor 12 stops the game and invokes the timer computer software.

If the user selects cartridge games option, the processor 12 next executes step 904a. At step 904a, the processor 12 prompts the user to insert the game cartridge into a cartridge slot which may be part of game portals 26 in FIG. 1. When the user inserts a cartridge into one of game portals 26, the processor 12 next executes step 904b, where the processor 12 invokes a computer software timer running on the processor 12 and sets the timer to zero. The processor 12 then uses the timer to prompt the user to pay. On payment, the timer resets to the predefined duration and the processor 12 next executes step 906. At step 906, the processor 12 checks the status of its computer software timer and as long as the timer is not zero the processor 12 executes the game, otherwise the processor 12 stops the game and invokes the timer.

If the user selects an Internet games option on the keyboard 40, then the processor 12 executes step 905a. At step 905a, the processor 12 presents a choice of Internet games on the monitor 24 and prompts the user to select one of them. When the user selects a game through keyboard 40, the processor 12 next executes step 905b, where a timer is invoked and set to zero. The processor then uses the timer to prompt the user to pay. On payment, the timer resets to the predefined duration and the processor 12 next executes step 907. At step 907, the processor 12, checks the status of the timer and as long as the timer is not zero, the processor 12 passes control to the game site otherwise the processor 12 stops the game and invokes the timer.

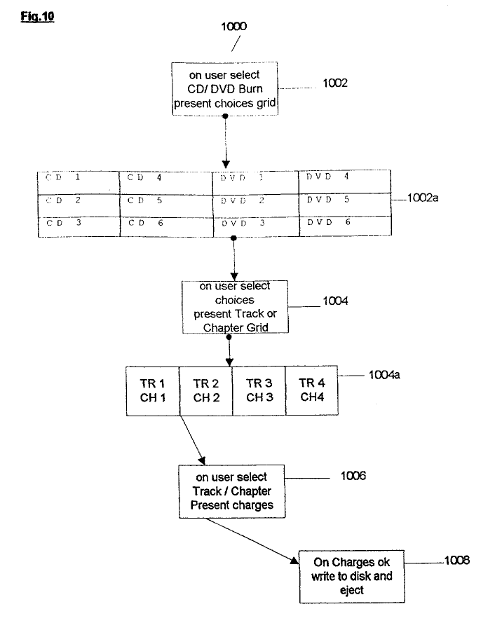

FIG. 10 shows a flow chart 1000 of a select CD/DVD Burning method which can be executed by the apparatus 10 of FIG. 1. At step 1002, the user has selected the CD/DVD burning option and the processor 12 causes the monitor 24 to display a plurality of CD/DVD choices in a grid-1002a.

Next at step 1004 the user selects an option via for example keyboard 40. If the user selects one of the CDs or DVDs, such as “DVD 4”, for example, the processor 12 presents a selection grid 1004a, which displays the tracks and or chapters, such as those of “DVD 4” in this example. The user can select any or all the tracks and chapters to be copied on to his CD/DVD. At step 1006 the charges are presented for the user's selection and request that an amount be inserted at the cash acceptance slot 22 of FIG. 1 or that a credit/debit/prepaid card be inserted into the card validator 18 in FIG. 1. At step 1008 when the charges have been accepted the CD/DVD selection, such as “DVD 4” in this example, is copied to a blank disk by the CD/DVD burner 28 in FIG. 1.

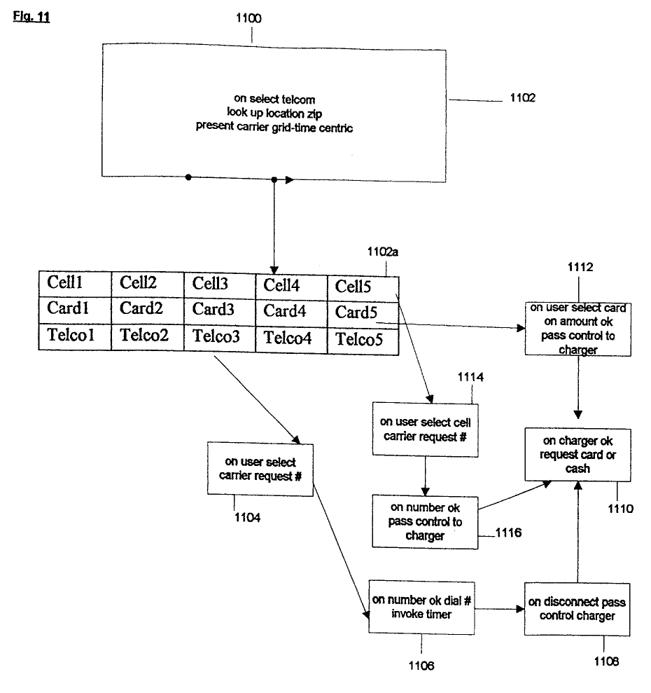

FIG. 11 shows a flow chart 1100 of a telecommunications method which can be executed by the apparatus 10 of FIG. 1. At step 1102 the processor 12 causes the monitor 24 to display a plurality of names of telecommunications companies or carriers which the user can select to handle for example a long distance call. A grid of the plurality of names of telecommunications companies or carriers may be displayed similar to that shown in 1102a

In the grid 1102a, Telcol-5, Cell1-5, and Card1-5 may be actual names of telecommunications carriers. “Telco1” may be, for example AT&T (TRADEMARKED), Telco2 may for example be VERIZON (TRADEMARKED), etc. The grid in 1102a may display the logos of various telecommunications carriers, in place of, or in addition to the telecommunications carrier's name.

The user may then select one of the telecommunications carriers at step 1104 by for example typing a selection on keyboard 40 or touching the location on the grid 1102a on the monitor 24. At step 1106 the user may dial a long distance phone number (for example by entering numbers into the keyboard 40) and a timer may be invoked by the processor 12 allowing a certain amount of time for a call if a user pays by cash (through for example cash or coin validator 22) or alternatively the processor 12 may time the call, if the user pays by credit/debit/prepaid card (through, for example, card/debit/prepaid card reader and validator 18). The call may be placed by processor 12 through communications boards 46 which may be connected to a telecommunication line or a transmitter for wireless operation. At step 1108 the call may be disconnected by the processor 12, if the timer has expired or alternatively the processor 12 may pass the charges to step 1110. At step 1110 the charges are billed to a credit/debit/prepaid card/debit/prepaid card (previously entered into card reader 18) of the user.

If the user selects a card option in grid 1102a the processor 12 passes control to step 1112. At step 1112 the user selects an amount for which he needs a card and inserts his card/debit/prepaid card into the card reader 18 in FIG. 1. Then the processor 12 passes control to step 1100. At step 1110 the charges are billed to a card/debit/prepaid card (previously entered into card reader 18) of the user and the processor 12 phone card is printed at the printer 34 of FIG. 1.

If the user selects a cell phone option in grid 1102a, such as “Cell 1” the processor 12 passes control to step 1114. At step 1114 the user selects an amount for which he needs his cell phone validated and inserts his card/debit/prepaid card into the card reader 18 in FIG. 1. Then the processor 12 passes control to step 1116 where he enters his cell phone number. Then the control passes to step 1110. At step 1110 the charges are billed to a card/debit/prepaid card (previously entered into card reader 18) of the user.

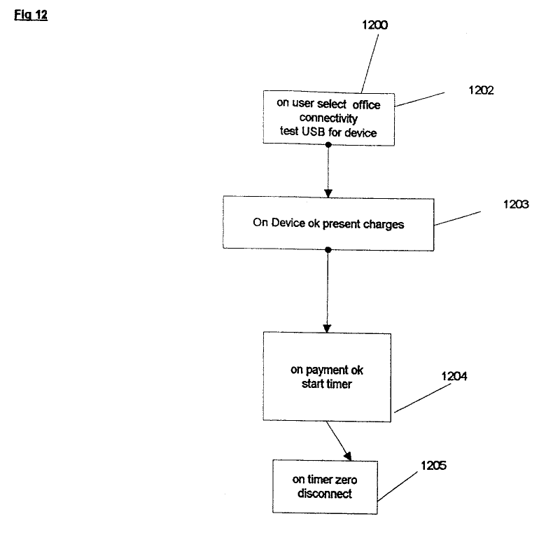

FIG. 12 shows a flow chart 1200 of a selected office connectivity method, which can be executed by apparatus 10 of FIG. 1. At step 1202, the user has selected a device to connect to a USB port which may be part of Notebook and other device portals 42 of FIG. 1, through for example keyboard 40. The processor 12 “pings” (a process known in the art) the attached device to test if it can communicate with the device. When the results of the pinging are positive the charges are presented on the monitor 24 at step 1203. At step 1204 the user approves the charges and by doing so sets the timer. When the timer has no more time left on it the processor 12 stops all communication to the device attached to a USB port of the portals 42.

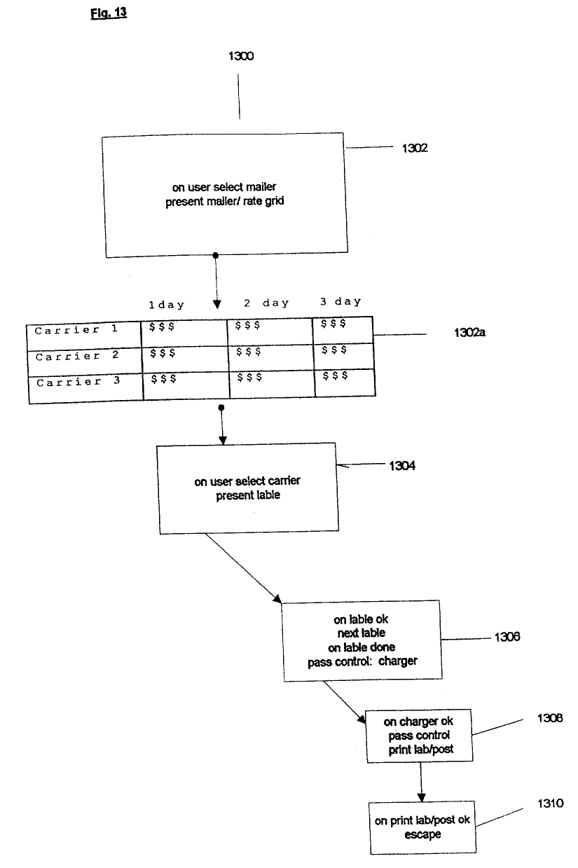

FIG. 13 shows a flow chart 1300 of a select mailer method which can be executed by the apparatus 10 of FIG. 1. At step 1302, the processor 12 causes a select mailer/rate grid 1302a to be displayed on the monitor 24. The grid 1302a may include various mail/package carriers.

When the user selects a given mail/package carrier step 1304 is executed. At step 1304, the processor 12 looks up a database on memory of the processor 12 for the particular mail/package carrier selected and presents an on screen label on monitor 24. At step 1306, when the user has completed one label and has more, additional labels are presented. When a user is done with all the labels, the processor 12 next executes step 308. At step 1308, the processor 12 tabulates charges for the mailer and charges these to the user's accounts, third parities, or credit/debit/prepaid card/debit/prepaid card, etc. Then control passes on to step 1310. At step 1310, the processor 12 prints the labels which are be used to mail letters, packages etc.

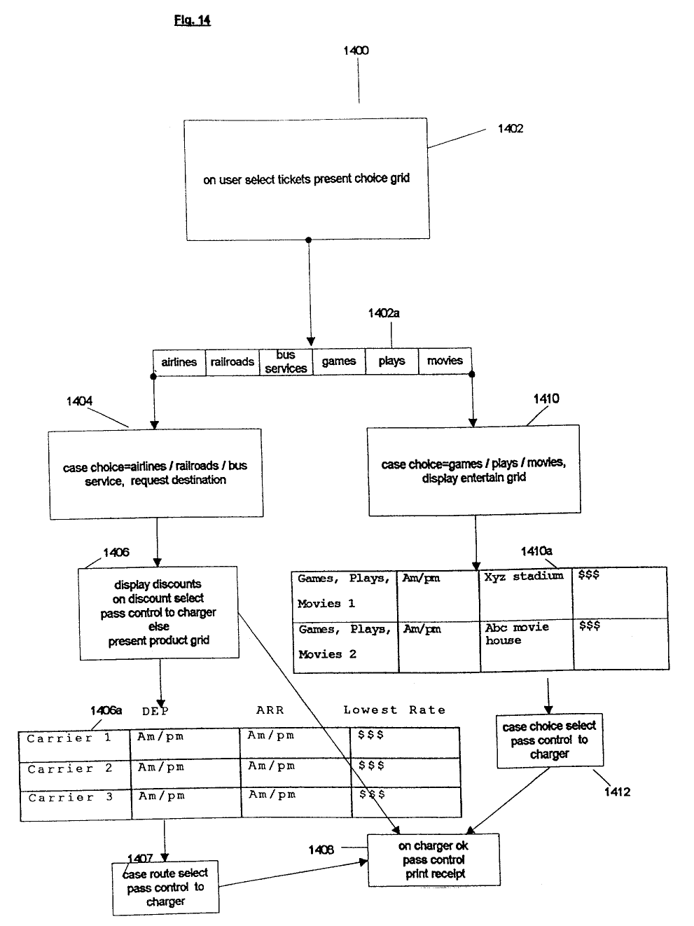

FIG. 14 shows a flow chart 1400 of a selected ticketing method which can be executed by the apparatus 10 of FIG. 1. When the user selects tickets on the keyboard 40 or on the monitor 24, the processor 12 executes step 1402 and presents a grid 1402a of available ticketing options. The option grid 1402a is location specific. For example, if the apparatus 10 is located in the vicinity of New York City, the processor 12 may cause the monitor 24 to display all spectator sports which are taking place in a forty mile radius, plays in a twenty mile radius, and movies in a five mile radius. If the apparatus 10 is in a location in a smaller town the radius may change. This programming technique is written in the computer software installed in the processor 12 and can be entirely user independent. On display of the option grid 1402a on the monitor 24, the user's selection of a choice determines the next outcome.

If the user selects any of the transportation buttons on the grid 1402a on the monitor 24, such as “airlines”, “railroads”, or “bus services”, then the processor 12 next executes step 1404. At step 1404, a user may type into keyboard 40 the following information, for example: destination, date of departure and number of seats the user wants to book. Once these entries are confirmed, the processor 12 at step 1404 looks up the database in the memory of the processor 12 specific to the location of the apparatus 10 and presents any discounts between competing transportation carriers on the monitor 24. The processor 12 next executes step 1406. The present invention in this embodiment allows all modes of transportation to simultaneously compete for the passenger, unlike the prior art where the competition is limited to a particular mode of transportation. In this embodiment of the present invention the user selects any of the discounted options presented on the monitor 24 in step 1406, then the processor 12 next executes step 1408. At step 1408, the user is charged for the tickets and the tickets are printed, for example, on printer 34.

If the user does not select any of the discounts on the monitor 24, the processor 12 at step 1406, looks up on its memory all the transportation carriers that operate on the user specified route and presents a grid 1406a on the monitor 24 of flights, trains, bus. If the user selects any of the available choices in grid of flights, trains, and busses. The processor 12 at step 1407, next confirms the user's selection and on approval by the user, via entry for example into keyboard 40, the processor 12 next executes step 1408. At step, 1408 the user is charged for the tickets and the tickets are printed, for example on printer 34.

If the user selects any of the entertainment buttons on the grid 1402a on monitor 24, such as “games”, “plays”, or “movies” at the processor 12 next executes step 1410. The processor 12 at step 1410 looks up a database in the memory of the processor 12 specific to the location of any apparatus like apparatus 10 and presents on the monitor 24 a grid 1410a, which would include the names of games, plays, or movies. If a user selects any of the available choices in the grid 1410a, the processor 12 next executes step 1412. At step 1412, the user enters the desired number of tickets, enters his seat selection if applicable and the date desired into the keyboard 40 or via the monitor 24, if the monitor 24 is a touch display screen. The processor 12 at step 1412 then determines if the particular ticket is available, and if available the processor 12 then executes step 1408, else the processor 12 requests the user via the monitor 24 to change one or all of the information he has entered. At step 1408, the user is charged for the tickets and the tickets are printed via printer 34 of FIG. 1, for example.

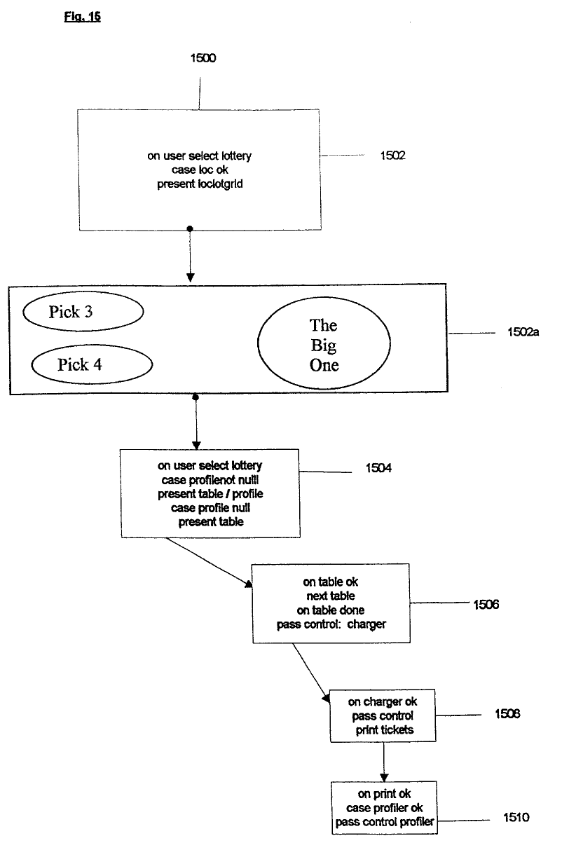

FIG. 15 shows a flow chart 1500 of a select lottery method which can be executed by the apparatus 10 of FIG. 1. At step 1502 a location based lottery data search is executed by the processor 12 and the results are displayed as shown in box 1502a on the monitor 24.

When the user selects a particular lottery via, for example, keyboard 40, the processor 12 next executes step 1504. At step 1504, the processor 12 asks the user for his lottery identification by displaying a request, for example, on monitor 24, and if a lottery identification is presented by the user by typing it into, for example, keyboard 40, the user's lottery profile is displayed on the monitor 24. This profile tracks the previous numbers the user has played, the user's choice or a series of numbers, etc. The user then has the option to use his predefined numbers or a new set of numbers.

If the user does not enter an identification, via keyboard 40 or in some other manner, an option is given for the user to create a profile to track his number. If the user chooses not to enter the profile mode he is given the option to choose his numbers. Once a ticket is selected control passes to step 1506. At step 1506, the processor 12 loops till such time that the user no longer wishes to buy any other tickets. If no more tickets are to be purchased then the control passes to step 1508. At step 1508, the processor 12 bills the charges for the tickets to the user's credit/debit/prepaid card, etc in jurisdictions or states which permits this or to a prepaid account via for example the communication boards 46 which may be connected to one or more telecommunication lines or channels. When payment has cleared the processor 12 next executes step 1510, where the tickets are printed, for example via printer 34, and a copy maintained with the payment information in the user's profile stored in computer memory such as memory of the processor 12.

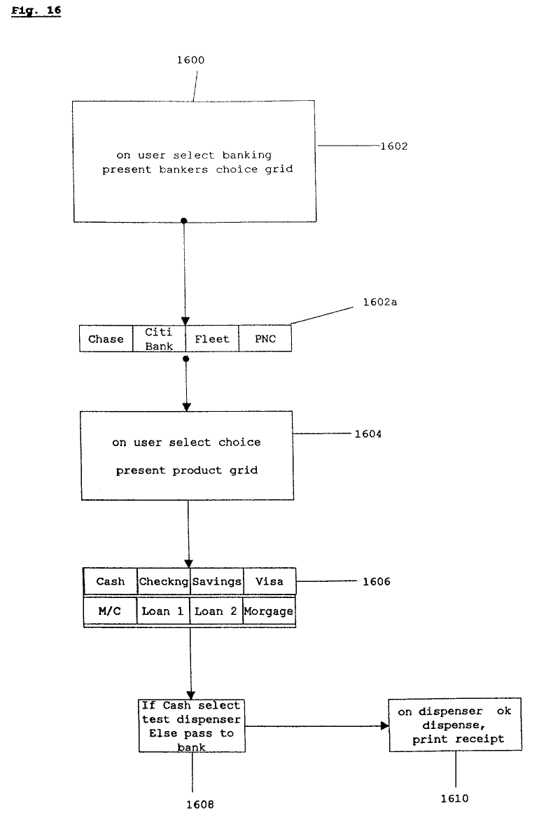

FIG. 16 shows a flow chart 1600 of a selected banking method which can be executed by apparatus 10 of FIG. 1. At step 1602, if the user selects the banking option on the monitor 24, the processor 12 will look up on a database in the memory of the processor 12 and display a grid 1203 of participating banks on the monitor 24. If the user selects any choice on the grid 1602a on the monitor 24, the processor 12 next executes step 1604. At step 1604, the processor 12 will look up a bank specific database in the memory of the processor 12 for any products and promotions. If a product or promotion is present, the processor 12 will display grid 1206 on the monitor 24. If a user selects any item or product in grid 1606, control is passed on to a specific bank to process the bank specific operators, such as via a telecommunications line connected to communications boards 46. If a user requests a cash withdrawal by selecting such an option in grid 1606 and the cash withdrawal is approved by the bank, the processor 12 next executes step 1608. At step 1608, the processor 12 tests the cash dispenser 58 for cash and if the cash dispenser 58 has cash, the processor 12 next executes step 1610. At step 1610, the requested cash is dispensed by cash dispenser 58 and a receipt is printed by printer 34.

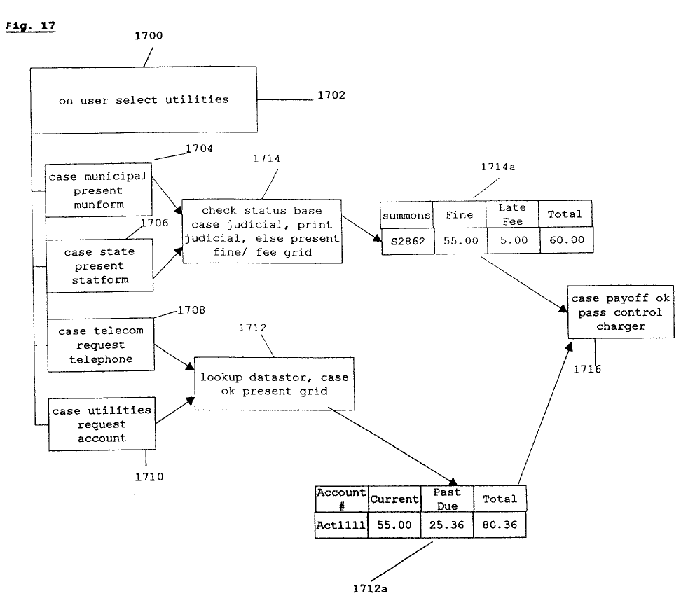

FIG. 17 shows a flow chart 1700 of a utilities method which can be executed by the apparatus 10 of FIG. 1. At step 1702, a user has selected the utilities feature by typing the appropriate keys on keyboard 40. The user can then select one of a plurality of selection screens to be displayed on the monitor 24. By typing the appropriate keys on the keyboard 40, the user can select a municipal selection screen at step 1704, a state selection screen at step 1706, a telecommunications selection screen at step 1708 or a utilities account selection screen at step 1710.

Diagrams/Tables Shown Below:

TABLE D6-1
Municipal selection screen

| | |
|---|---|
| Parking & Traffic Violations | Child Support Payments |
| Housing Department Violations | Real Estate Tax Payments |
| Health/Sanitation Violations | Permit Fees |

TABLE D6-2
State selection screen

| | |
|---|---|
| Parking & Traffic Violations | Income Tax Payments |
| Housing Department Violations | Real Estate Tax Payments |
| Health/Sanitation Violations | Permit Fees |

TABLE D6-3
Telecom and Cable payments selection screen

| | |
|---|---|
| Telecom Carrier 1 | Cable Carrier 1 |
| Telecom Carrier 2 | Cable Carrier 2 |
| Telecom Carrier 3 | Cable Carrier 3 |

TABLE D6-4
Utilities payments selection screen

| | |
|---|---|
| Electric/Gas Supplier 1 | Water & Sewer 1 |
| Electric/Gas Supplier 2 | Water & Sewer 2 |
| Electric/Gas Supplier 3 | Water & Sewer 3 |

If the municipal or state selection screen is selected then step 1714 is next executed by the processor 12. The processor 12 at step 1714 checks for the need for a court appearance and if a court appearance is required prints (for example, via printer 34) hearing dates and court location, phone etc and notifies a user's attorney if a user has validated a request to do so. The processor 12 may permit a user using keyboard 40 to reschedule on line court appearance dates if that option is available in the particular jurisdiction. If a court appearance is not required the processor 12 displays on the monitor 24 a list of summons, the fines and penalties due in grid 1714a. The user then may select using the keyboard 40 the summons to be challenged or paid. For those that the user challenges he can validate the court date or request alternative dates on line, for those that he chooses to pay he has the option to pay online by card/debit/prepaid card or online check through for example communication boards 46 which may be electrically connected to one or more communication lines. The processor 12 would execute step 1716 as soon as the user has authorized those summons that are to be paid. At step 1716, the processor 12 charges the user's credit/debit/prepaid card, debit, prepaid card, or online check.

If steps 1708 or 1710 were selected, then a search of a database located, for example in memory of the processor 12, is performed for charges and delinquencies related to phones and utilities at 1712. The processor 12 displays the results on the monitor 24 similar to grid 1712a. When the user approves the charges control passes to step 1716. At step 1716, the processor 12 charges the user's credit/debit/prepaid card, debit, prepaid card, or online check. The processor 12 may charge through the communication boards 46 and to one or more communication lines which may be connected to boards 46.

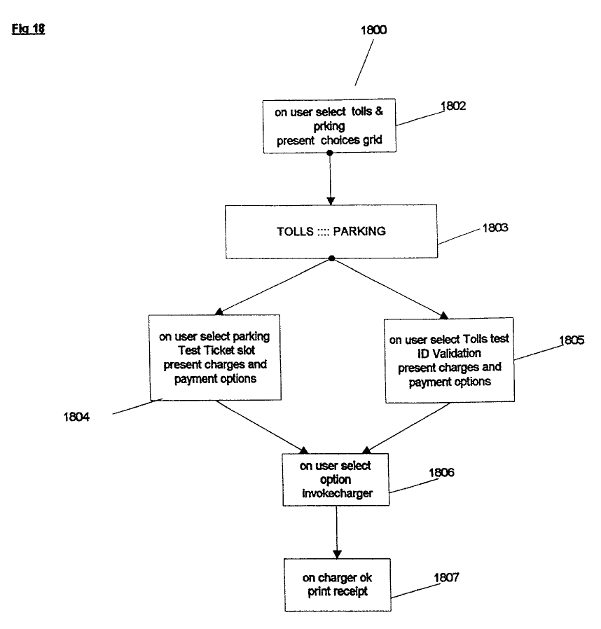

FIG. 18 shows a flow chart 1800 of a selected parking ticket/tolls method which can be executed by the apparatus 10 of FIG. 1. At step 1802 the user has selected parking tickets/toll payment option on the monitor 24 or via the keyboard 40. At step 1802, the processor 12 looks up an allocation centric database in for example, the memory of the processor 12, and the processor 12 presents a choice of parking and tools at step 1803 on the monitor 24. When the user selects the parking ticket option at step 1803, via for example the keyboard 40, the processor 12 next executes step 1804. At step 1804, the processor 12 will look up a sub database in the memory of the processor 12, related to the selected choice and present the charges and payment option on the monitor 24 at step 1806. When the user approves the charges, by hitting for example the enter key on the keyboard 40, the processor 12 next executes step 1807. At step 1807, the charge is validated by the processor 12 via for example a telecommunications line connected to communications boards 46 and a receipt is printed on printer 34.

When the user selects tolls option on monitor 24 at step 1803, the processor 12 next executes step 1805. At step 1805, the user is requested by the processor 12 by a message displayed on the monitor 24 to enter his identification information at the keyboard 40 in FIG. 1. If the identification is valid, the processor 12, at step 1805, will look up a sub database related to the selected choice on the memory of the processor 12 and present the charges and payments options on the monitor 24 at step 1806. When the user approves the charges by for example hitting enter on the keyboard 40, the processor 12 next executes step 1807. At step 1807, the charge is validated by the processor 12 and a receipt is printed on printer 34.

The apparatus 10 in one or more embodiments of the present invention is an all in one machine that replaces many single task machines. The apparatus 10 can be configured in an all-features enabled mode or selected-features enabled mode. The component enablement or disablement is done by validating or invalidating the feature at time of installation of computer software for running the various features onto the processor 12. The installation computer software presents on the monitor 24 a list of features that are all check marked. Those that need to be disabled would be unchecked by the installer using the keyboard 40. For example, the cash dispenser 58 may be enabled so that it can be used by an individual while the high resolution scanner 48 may be disabled so that it can not be used by the individual.

The result of this location specific feature-selectable design is that the apparatus 10 can be a universal machine for multiple locations. By incorporating various features into a single apparatus 10, the needs of the customer for a one-stop-shop of services have been recognized. It enhances the revenue stream of a vendor by incorporating various functionalities as described below.

The apparatus 10, shown in simplified block diagram form in FIG. 1, is a multi-purpose advertising/access tool for easing communication, carrying out chores and a web-initiated source of information.

The location specific device selectable feature can engage or disengage a particular device or component of components 14-62 in FIG. 1, a set of such components, as the vendor's location demands. For example the shopper centric sale generator, which is executed by the processor at step 402 in FIG. 3 may have minimal value in a railroad terminal. But a customer oriented shopping guide with instant ticket generation provided through the processor 12 and the printer 34, for example, can enable the customer to shop for and buy the best value for his travel needs. Currently all customers at the railroad or airline terminal are at the mercy of the service provider.

The apparatus 10 can function as an advertising/access device. When the apparatus 10 is not in use, instead of displaying a blank screen on the monitor 24 of the apparatus 10, the processor 12 may be programmed to display a continuous stream of advertisements on the monitor 24. Since the apparatus 10 can be set up to work alone or in conjunction with any number of other machines like apparatus 10 in a network, advertisements can be site specific, such as single store ads or can be regional or national such as those used by mass media marketing companies. This continuous stream of advertisements displayed on the monitor 24 would be sold by the owner/operator of the apparatus 10 and could be a revenue generator for the owner/operator of apparatus 10. Also since the apparatus 10 is typically always on, the ad frequency and length of each advertisement can be remotely controlled by computer software. The ads running on monitor 24 would be running as long as the apparatus 10 is “not in use”.

To operate the apparatus 10, an individual, can insert a quarter into a coin slot (not shown) of the coin validator 22. The individual could also insert a card or a currency bill (such as a one dollar bill) in the card reader and validator 18. In one example, when the individual inserts a quarter into the coin validator 22, the individual may be given a fifteen minute span for his or her use of the various features of the apparatus 10. The various features have been outlined above and are explained in detail here.

At the time of installation of the computer software for controlling processor 12, the installer selects the appropriate location grid, time zone, zip code etc. to be installed on the processor 12. This information is then passed on to the main database maintained on a web site server or collection of web site servers. (not shown).

For example in malls and airports, only general view content may be made available by the processor 12 on the monitor 24. What may be made available may be determined by inputs provided via the multi-mode keyboard 40 or a computer mouse (not shown) which can be connected to the bus 12a of from a data base. In schools, age dependent content can be displayed on monitor 24 and adult content can be locked out by a location centric adult content lockout mechanism 56 shown in FIG. 1. Other child centric geographic areas such as children's play areas in a shopping mall, can have general content and shopping cart features turned off, by using the location centric adult content lockout mechanism 56 by turning on this feature at the time of software installation on the processor 12 to prevent user abuse. Further this protects the children from unwanted web sites and chat rooms. A line of computer software filters may be maintained by third parties, and may filter out material unsuitable for children. The third parties may charge a fee for their filtering process.

In operation, computer software in accordance with the present invention, running on the processor 12, triggers various site selection switches to on or off positions based on the physical geographical location of the apparatus 10. As an example for schools with kindergarten through third grade only sites like DISNEY (TRADEMARKED) would be allowed. The internet browser will not approve of visits to sites not appropriate for children in the age group. The site selection switches will vary.

The site and content providers (such as AOL(TRADEMARKED)) will then be delivering only child centric contents, advertisements and features and displaying these on the monitor 24 of the apparatus 10. This helps the content providers better market the products of their customers and have a dedicated audience.

The apparatus 10 is always “on” in a general sense although some of the features or components 14-62, shown in FIG. 1, may be disabled. Hence, when the user or individual inserts a quarter into the coin slot of the coin validator 22, the coin validator 22 sends a signal to the processor 12 and the processor 12 then switches the monitor 24 onto the “use” mode. This allows the user to operate the apparatus 10 as a simple computer, for example by typing information into the multi mode keyboard 40. The apparatus 10 may have all the available computer software as is generally found on any desktop computer. For example, the user may access the WORD (TRADEMARKED) by MICROSOFT (TRADEMARKED) program, write and print letters, run EXCEL (TRADEMARKED) programs or if required, by inserting his/her diskette, access his/her information for his own work. The programs may be stored in for example, memory of the processor 12 or in memory of licensed software 50 The notebook and other device portals 42 shown in FIG. 1, may include a floppy disc drive. The apparatus 10 has the following:

A) General Features:

A1) A user selectable internet enabled public access pay per use computer;

A2) A location, time, date, event centric advertising tool;

A3) A shopper centric sale generator; and A Point-of-Sale advertising/discount coupon generator

A4) A location centric tickertape generator for stock exchanges, game scores, racing etc;

A1) A User Selectable Internet Enabled Public Access Pay per Use Computer.

The apparatus 10 can be used as a user selectable Internet enabled public access pay per use computer.

In the apparatus 10 of the present invention, the customer chooses the service provider by selecting the appropriate icon-tab or field on the monitor 24. This can be done by touching the monitor 24 in touch screen installations or using the up and down key on the standard keyboard 40 or computer mouse. The keyboard 40 or mouse can be considered user interactive devices. Further with respect to apparatus 10 the customer only pays for the use of the apparatus 10 and not for the content/access once he has an access service account with any of the content/isp. Further account signup is offered to a variety of Isp/content providers, unlike prior art devices, which have offered only one choice of internet service provider.

Prior art does not allow for a choice of access or content providers. In prior art the user is automatically directed to the access or content provider approved by the installer. In prior art after entering the content providers site he may or may not be allowed to move to his desired content provider

A2) A Location, Time, Date, Event Centric Advertising Tool.

Unlike Internet machines of the prior art, the apparatus 10 can provide a location, time, date, and event centric advertising tool. Based on the location, time, date, and event, a main advertisement web site server pushes the content on to individual monitors, such as monitor 24.

The processor 12 causes the monitor 24 to provide location centric ads. For example if the monitor 24 is physically located in a mall, the processor 12 may cause the monitor 24 to display more shopping advertisements and also more promotional material on the monitor 24 from manufacturers. If instead, the monitor 24 is physically located in a school or children specific area, the processor 12 may cause the monitor 24 to display information which concentrates on goodies for kids. In addition a sub market for each sub section of kids may be presented on the monitor 24.

When not in use by a customer, the monitor 24 may be switched to an advertising mode by the processor 12. If the apparatus 10 is in a mall the advertisements placed on the apparatus 10 during the advertising mode could be “sale” announcements. If the apparatus 10 is located in an airline terminal the advertisements displayed on the monitor 24 when a customer is not using it could be advertising the latest fares from a particular airline. By increasing the number of individuals who see an advertisement, the apparatus 10 becomes one more space for companies for their advertising campaigns.

A3) A Shopper Centric Sale Generator; and A Point-of-Sale Advertising/Discount Coupon Generator

The present invention can provide a shopper centric sale generator. Prior art coupon machines in a shop are just coupon machines, where you press a button and you get some coupons. After your purchase a product, the competing product company will generate a coupon for their product on your next purchase. This prior art mechanism and feature may be satisfactory for groceries, but is useless for electronics and other house hold items which are not purchased on a weekly basis like groceries. In prior art the standard directory service that malls provide generate a list of stores and where they are in the mall. Some have a look up table for items and items on sale.

The apparatus 10 provides a look up table for products and their prices plus a look up table of competitive products and prices, all of which can be stored in the memory of processor 12. The apparatus 10 also may pre sell a product by giving instant discounts and rebates at the time of inquiry and not at the time of sale towards a future purchase. These rebates or coupons may be provided by processor 12 through high resolution printer 34. The instant coupons create a sales lead and close the sale prior to the customer even entering the shop. Alternatively, the processor 12 of the present invention may produce a coupon through printer 34 to generate a sale immediately or during a subsequent visit. Currently the apparatus 10 may be configured so that there is no cross competition during an inquiry of a specific product in the mall. The processor 12 may dynamically look up competition—manufacturer on inquiry of a product and generate a sales lead and move through the cycle established above.

A4) A Location Centric Tickertape Generator for Stock Exchanges, Game Scores, Racing etc.

In prior art ticker tape generating mechanisms provide for a streaming information tape of game scores, stock market information, and news items. They are not selective in providing localized information.

The tickertape generator feature in the present invention causes the processor 12 to display on the monitor 24 information on regional, national, and international stock exchanges, game scores, racing, media & sports events etc.

In operation, computer software in accordance with the present invention, running on the processor 12, triggers various site selection switches to on or off positions based on the physical geographical location of the apparatus 10. As an example for devices located in international airports the ticker tape will provide international stock market, game scores, and news etc in addition to the regional of the city where the airport is located and national content of the country in which the city is based. The site selection switches will vary.

Show Grids

The apparatus 10 may have the following

B) entertainment features;

B1) A pay-per-use and pay-per-view television;

B2) A gaming tool for

a) resident games;

b) users own game cartridges

c) internet games

B3) A CD/DVD burner for customized web enabled and downloaded music, & video.

B1) A Pay-Per-Use and Pay-Per-View Television.

The processor 12 may cause a pay-per-view television program from the TV and Cable tuner card 20 to be displayed on the monitor 24 if an appropriate amount of money is deposited in either the coin validator 22 or the card reader and validator 18. Combining the TV with the internet is another important feature provided by the present invention. The current invention may provided regular cable television, satellite television and web television choices, further pay per view television, on demand television, or on demand videos. Music/stunt game videos can be seen on demand and clipped to customer's choices.

The present invention in one or more embodiments not only enables one to see a television show as it appears on the monitor 24, it enables one to cut and reframe the scenes on a live basis by the use of keyboard 40, or a mouse through processor 12. Current videos or TV does not allow one to do this. The processor 12, via computer software programming, achieves this by redirecting every video frame to a memory bank of the processor 12, where the video frame stays until the entire process is completed. A user can swing back and forth between live television and play back with out losing any video frames or video scenes. A user can then record the whole matter or cut and paste frames to their liking. Again this location centric TV pumper can trigger an on and off invitation to view television or a television program for a given target market.

B2-a) A Gaming Tool for Resident Games.

The present invention in one or more embodiments provides gaming tools which are not the standard one game per machine as per the prior art video game parlors or the prior art computer loaded games or the prior art internet games. The apparatus 10 of the present invention may be designed to provide all of the above plus the ability to play with multiple players on the same game—a game of challenges. Prior art gaming devices are independent machines with no such ability. Furthermore prior art gaming devices do not allow one to store and recall one's gaming ability on subsequent plays. Currently only the top ten scores for that machine is stored. The apparatus 10 gives the customer the ability to store his/her individual score. This is done by providing an input screen where the user saves his bio-graphics, his games and his scores. Each time he obtains a higher score the database updates its file with the new score. This way his user profile is always current

The processor 12 invokes a user profile and a monitoring device which are provided through computer software running on the processor 12, to rate the gamer and his games, maintain his score across the internet can use a trigger to recall his plays and scores and his skill level.

B2-b) A Game Enabler for Users own Game Cartridges:

A user can insert his game cartridge in the game portal 26 in FIG. 1, just the way one inserts a floppy disk into a floppy drive. The ability to accept your game cartridge and play your game has been incorporated by providing a game portal 26 in FIG. 1 with connectors for the most popular game machines like PLAYSTATION (trademarked), POKEMAN (trademarked) and NINTENDO (trademarked).

Further the game can be played with another or a number of other friends who are on other apparatus similar to apparatus 10. In any given mall a number of apparatus 10 will have been placed. They are all can be connected to each other through cat 5 cables or higher bandwidth cables thru the communication boards 46 in FIG. 1. They may also be connected with out cables—wireless. The communication boards 46 in FIG. 1 emit wireless signals that other apparatus like apparatus 10 can accept. There are no public domain gaming machines that offer the feature of an individual playing your own game cartridges. Further apparatus 10 allows an individual to burn a game on a DVD/CD reader burner 28 rather than going to the store and buying a cartridge. This unique methodology results in rapid deployment of games and enhances the distribution channel of the game makers.

B2-c) An Internet Enabled Gaming Machine

An Internet Enabled Gaming Machine.

The present invention may be used as a gaming machine for pay per game internet games. The apparatus 10 of the present invention may be designed to display a selection of games on the monitor 24. When the user selects a game and deposits the required amount either through the cash acceptance device or card reader the processor 12 causes the communication device to communicate with a game server on the internet. A timer is invoked and the user is allowed to play on the game till the timer has no more time left on it.

B3) A CD/DVD Burner for Customized Web Enabled and Downloaded Music, and Video Recording.

In this machine the user can customize the music or the TV frames and record it onto a CD or DVD. Movies can be recorded on the machine and then replayed by the user frame by frame. It would allow the user to delete unwanted parts and select certain parts for creating a customized disc. This customized file can then be recorded by the CD/DVD burner into a custom disc for the users pleasure. The same can be done for music. The user can then select the songs from a single artist or songs from many artists and create a custom disc for his/her listening pleasure.

The computer software in the machine enables the user to select individual frames or individual songs. These can then be compiled into a custom file. In each case, protection has been provided so that the company or the artist are reimbursed by the user for the viewing or hearing of the frame or song. The processor 12 causes the CD/DVD burner to create a unique and custom disc. There could be various songs from a single artist or many artists. In this case you would pay only for what you want not for the whole album. Artists themselves would love this as this will increase the sales and also more money goes directly to them rather than the distribution channel.

In the apparatus 10 you can burn through the DVD/CD reader burner 28 via processor 12 only the songs you like after paying a fee directly from the artists web site via broadband/standard communication boards 46. A home computer used for this purpose is subject to abuse by the user, a public domain apparatus 10 is not. Currently the well known artists do not allow this feature because of potential piracy. Through pass wording and embedding a required file piracy can be stopped, as subsequent reproduction will not copy the embedded file. The password will dynamically change for each down load and will be maintained in a customer profile database. If the customer claims that his CD or DVD does not work properly he can reinsert the same disk, the disk will be destroyed and new one produced. Similarly DVD and game videos can be cut and burnt.

The apparatus 10 may provide the following

C) communication services:

C1) An Internet telephone and videophone with user selectable carrier

C2) A portal for office connectivity to hand held devices and notebooks.

C3) Multicolor printing capability to enable instant hardcopy generation.

C4) Email capability

C5) Fax Capability

C1) An Internet Telephone and Videophone with User Selectable Carrier

Apparatus 10 includes handsets/headsets 38 as well as a high resolution camera/video camera 36. With the advent of the Internet phone and the videophone it is now possible to have voice and video communication over the Internet. However, the user will have access to various providers and will have the companies bidding for his business. The user can then select his carrier and use this feature to communicate at the best value. When the user selects the telecom option as described in FIG. 4, a grid of telecom carriers along with their rates appears—see description for telecom FIG. 4 page 8 and page 9. The user can then click on the screen using his mouse or type the carriers name to select the carrier. The carriers can continuously update their database of rates and these will appear on the telecom grid as presented here.

The business process of one or more embodiments of the present invention lets a customer select a carrier after checking the price of the call. The carrier's prices are dynamic and not static as in current phones or calling cards. The truly carrier independent phone does not exist in the prior art, but is now provided by the present invention.

Further the phone/videophone feature of the present invention is enhanced by a kid safe feature. This feature will tell the called party where exactly the phone is (unlike prior art devices where a tracer has to be used with the intervention of the 911 operator or the phone company). It is extremely useful for a lost child, in case of medical emergencies, and to keep a track of your teenagers. At the receiving end you will hear the phone number and location, it can be recorded or on push of a button forwarded to a key person—police EMS etc, if you are on the net this information flashes on your screen and is stored in memory till deleted. To recall info on phone one just presses a button such as the * button on the phone at your home or office and the message repeats.

C2) A Portal for Office Connectivity to Hand Held Devices and Notebooks.

The communication port, 42 in FIG. 1, may include a USB port, 42. By connecting portal 42 to a computer notebook or a handheld device the user now has access to download anything from the Internet on to his handheld device or laptop device via portal 42. This feature would be of great advantage to the business traveler who has to have instant access to the office or central server for instant communication.

C3) Multicolor Printing Capability to Enable Instant Hardcopy Generation.

A multi-color printing capability may be provided by high resolution printer 34. This may be a standard feature allowing for ease of communication for, for example a business traveler. Business travelers can create their own letters and have a printed copy for giving their customer or for their own files. Individuals could use this feature to create custom greeting cards. By using the video camera they can create custom postcards for mailing to their family and friends.

C4) Email Capability

The apparatus 10 may have e-mail capability through the broadband/standard communication boards 46 in FIG. 1 which may be connected to an internet communication device

C5) Fax Capability

The apparatus 10 may have fax capability through the high resolution scanner—46 in FIG. 1 which may be connected to an telecommunication device.

The apparatus 10 may provide the following:

D) Personal Utility Services:

D1) A Public Access, Carrier Independent Postage Generator

Prior art machines are carrier dependent—UPS (TRADEMARKED) has its own machine, the United States postal service has its own, Fed Ex (TRADEMARKED) its own etc. The present invention combines the capabilities of all these into one single machine. It further allows the mail/package carriers to be competitive by offering discounts to increase their market share. For example before the user selects a given mail/package carrier, the mail/package carriers rates appear in a grid. The carriers can entice the user by presenting a coupon or discount at this stage

Apparatus 10 includes a printer-34 with trays for various labels, paper sizes and cards.

When the user selects the mail/package option (by either touching an icon on the mail/package selection screen or clicking the mouse or by using the keyboard), the processor 12 presents a grid of mail/package carriers along with their rates on monitor 24. The user can then click on the screen using his mouse or type the carriers name to select the carrier. The mail/package carriers may continuously update their database for new rates and these will appear. Further they can provide discounts by popping a discount on the monitor 24.

The business process of one or more embodiments of the present invention lets the customer not only print postage stamps, but also labels for packages.

FIG. 13 presents a flow chart of the process involved and explanation of the flow chart for FIG. 13 explains the process involved.

D2) A Custom Greeting Card Generator;

Among the advertisements presented on monitor 24 when the computer is not in use, advertisements for greeting card companies like hallmark, etc could be presented. They could also be presented as a static item on a portion of the monitor 12 or as a pop up item when the user for example is viewing some thing. When the user clicks the greetings advertisement, a sampling of greetings from the greeting card company could be projected by the processor 12 on to the monitor 24. This could then be customized by the user using any input device such as the attached keyboard 40 and printed at the printer-34 in FIG. 1

Prior art mechanisms allow the user either to buy a card and the company providing the card mails the card for the user or the user can send an email greeting. There is no mechanism to print any customized cards other than the email cards.

D3) A Ticket Generator for Games, Plays, Airlines etc;

The processor 12 may generate tickets through the printer 34 in response to a request from a user via keyboard 40 or via a mouse.

The travel ticket feature of the apparatus 10 will actively seek carriers as illustrated in the explanation for FIG. 14 for your travel and when a sale is consummated print the ticket and boarding pass with luggage tags. The prior art business process is for one to book via phone or the Internet and then go to the e-ticket machines at the airport and pick tickets or stand in line for tickets. If airlines want to shut off the boarding pass or baggage ticket feature they can do so, they have the choice for global shut off or selective route and route and day, or route day and time based shut offs. This business process will cut down the wait times for clients by up to 30 minutes the total time saved would be of a great magnitude. Further the airlines can reduce the front-end staff and save on human resources costs.

The entertainment ticket feature of this apparatus allows the user to view, select, pay and print entertainment tickets for games, plays, movies etc. The illustrations of the process are outlined in explanation for Fig

There is no prior art device that markets entertainment tickets.

D4) A Location Centric Lottery Ticket Generator with Customer Driven Selection Storage and Recall for Replay.

The processor 12 may generate tickets through the printer 34 in response to a request from a user via keyboard 40 or via a mouse or the touch screen monitor. The illustrations are outlined in FIG. 15 and explanations there on. None of the prior art machines provide for lottery purchase with data tracking and recall frequency features. This means that the users information is stored for recall by the user and in case of some one not claiming a price by the lottery authorities. Multi state and multi lottery, self serve lottery machines other than those preloaded with scratch off games has not seen the light of the day.

D5) A Banking Device with Cash Dispenser and Banking Chores;

The apparatus 10 may have capability to dispense cash, and transact any banking activity.

The processor 12, may on the users command through users input via say the keyboard present a selection of banks on the monitor 24. When the user clicks on his choice of banks through processor 12 communicates through the communication boards 46 with the banks server. The user may then proceed to obtain a cash withdrawal by inserting his ATM card in the card reader and providing the PIN (personal identification number). The user has the ability to transact any transactions authorized by his bank. The processor may at times display promotional materials stored in its database or that are obtained through the communication board from the banks server.

D6) A Utilities, and Municipal Tickets Payment Device;

The apparatus 10 may have the capability to accept payment for utilities, municipal summons, taxes etc.

The processor 12 may check for the need for a court appearance and if a court appearance is required prints (for example, via printer 34) hearing dates and court location, phone etc and notifies a user's attorney if a user has validated a request to do so by means of an interactive input device such as keyboard 40. The processor 12 may permit a user, using keyboard 40 to reschedule on line court appearance dates if that option is available in the particular jurisdiction. If a court appearance is not required the processor 12 displays on the monitor 24 a list of summons, the fines and penalties due. The user then may select using the keyboard 40 the summons to be challenged or paid. For those that the user challenges he can validate the court date or request alternative dates on line, for those that he chooses to pay he has the option to pay online by card/debit/prepaid card or online check through for example communication boards 46 which may be electrically connected (hardwired and/or wireless) to one or more communication lines.

The processor 12, may on the users command through user's input via say the keyboard 40 perform a search on the database of a utility provider for charges and delinquencies related to phones and utilities. The processor 12 displays the results on the monitor 24 and proceeds to charge the user's credit/debit/prepaid card or online check for items the user authorized. The processor 12 may charge through the communication boards 46 and to one or more communication lines which may be connected to boards 46.

There are no public access prior art devices that perform the above functions.

D7) A Location Centric Parking Garage Payment Device (for Malls, Airports, Stadiums etc.);

Unlike prior art parking ticket payment acceptance machines the process of this embodiment of the present invention is independent of the parking lot operators. The apparatus 10 can accept any and all operator's tickets, thereby eliminating multiple machines. Further the prior art machines accept only payment for parking tickets, they are single function, single parking lot/garage operator machines.

One feature of these machines is a software that keeps track of the number of parking slots, the number occupied and the number available at any given time. This can be displayed at the gates of the parking garages eliminating the guess work of how long a user has to wait for a slot.

Further these machines can accept payment for tolls such as monthly toll passes, EZ pass etc.

Various individual features provided by the apparatus 10 are novel and have not been done in the prior art. Some devices known in the prior art have one or some of the features of the apparatus 10. However, the devices of the prior art are not all-inclusive multipurpose machines. The combination of various features eliminates the need for various machines and changes the business process. This method of doing business is new. In the same space currently occupied by a telephone we now have a multi personality machines. This increases the revenue for the owner of the machine, be it a franchisee or a mall operator.

None of the prior art public access pay per use or free use machines provide user selectable internet services from a plurality of internet service providers. Similarly they do not provide user selectable telephone services from a plurality of telephone service providers.

Location and or crowd and or date and day centric advertisement generating devices do not exist in the prior art. The present invention in one or more embodiments can generate location specific advertisements. Further the advertisements can be programmed on the processor 12 to be crowd centric. Time of day and the day is used as a prompt for generating day and date centric ads. This micro managing of advertisements may produce the largest return per ad dollar. The advertisements of the prior art currently on the Internet can be viewed only when one turns the machine on. The advertisements of embodiments of the present invention can be timed to come on and are programmed through the processor 12 to produce full screen blasts on the monitor 24 when the apparatus 10 is idle at the user's end. Further with the cable TV feature of the apparatus 10, the advertisement blasts are programmed through processor 12 to run on the monitor 24 even when a TV signal is not being watched on the monitor 24. This feature is identical to a TV being off and then comes on to blast an ad and then shuts off.

The advertisements on most prior art Internet machines are on when one is accessing the net otherwise they show a blank screen or an invitation to use the machines. The apparatus 10 of the present invention is engineered to display various advertisements on monitor 24 and also to display on monitor 24 an invitation to use the various features. Furthermore, the ads are triggered to reflect national ads, location specific and event specific, manufacturer triggered etc. this ability to present various items did not exist in the prior art.

A single slot for card acceptance (debit, credit/debit/prepaid card, prepay etc) may be provided as part of the card reader and validator 18, for a variety of services. The copyrighted software receives triggers based on the customers' input into the multi mode keyboard 40 and places the appropriate charges against the appropriate card inserted into the card reader and validator 18. An alternative cash acceptance slot, for bill acceptance may be provided through card reader and validator 18 for those who do not have a card.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising
a computer processor;
a monitor;
wherein the computer processor causes the monitor to display advertising and the content of the advertising depends on the physical location of the monitor.

2. The apparatus of claim 1 wherein
the computer processor causes the monitor to display advertising and the content of the advertising depends on the time of day or date or an event.

3. An apparatus comprising
a monitor;
a user interactive device;
and a computer processor which is electrically connected to the monitor and the user interactive device;
wherein the computer processor causes the monitor to display a menu of a plurality of telecommunication or internet carriers and upon a user selecting a first carrier of the plurality of telecommunication or internet carriers via the user interactive device, the computer processor enables communication via that first carrier.

4. The apparatus of claim 3 further comprising
a means for receiving money; wherein the computer processor enables communication via the first carrier only if a first amount of money is received by the means for receiving money.

5. The apparatus of claim 4 wherein
the means for receiving money includes a credit/debit/prepaid card reader.

6. The apparatus of claim 4 wherein
the means for receiving money includes a currency bill validator.

7. A method comprising the steps of
receiving money for a pay per use computer; and
enabling operation of the pay per use computer via the Internet.

8. A method comprising the steps of
determining the physical location of a computer monitor;
causing the computer monitor to display advertising, the content of which depends on the physical location of the monitor.

9. The method of claim 8 further comprising
determining the time of day;
wherein the content of the advertising displayed depends on the time of day and or date.

10. A method comprising the steps of
displaying a menu of a plurality of telecommunications carriers;
receiving a user selection of a first carrier of the plurality of telecommunications carriers;
and enabling a user to communicate via the first carrier.

11. The method of claim 10 further comprising
receiving a first amount of money;
and wherein the user is enabled to communicate via the first carrier only if the first amount of money is received.

12. The method of claim 10 wherein
the first amount of money is received by reading a card/debit/prepaid card.

13. The method of claim 10 wherein
the first amount of money is received by receiving currency.

14. An apparatus comprising
a monitor;
a user interactive device;
and a computer processor which is electrically connected to the monitor and the user interactive device;
wherein the computer processor causes the monitor to display a menu of a plurality of mail/package carriers and upon a user selecting a first carrier of the plurality of mail/package carriers via the user interactive device, the computer processor enables the printing of labels and postage of that first carrier.

15. The apparatus of claim 14 further comprising
a means for receiving money; wherein the computer processor enables the printing of labels and postage of the first mail/package carrier only if a first amount of money is received by the means for receiving money.

16. The apparatus of claim 15 wherein
the means for receiving money includes a credit/debit/prepaid card reader.

17. The apparatus of claim 15 wherein
the means for receiving money includes a currency bill validator.

18. A method comprising the steps of
displaying a menu of a plurality of mail/package carriers;
receiving a user selection of a first carrier of the plurality of mail/package carriers and enabling a user to print labels and postage for the first mail/package carrier.

19. The method of claim 18 further comprising
receiving money for a pay per use computer; and
enabling the printing of labels and postage/mail charges for the selected mail/package carriers.

20. An apparatus comprising
a monitor;
a user interactive device;
and a computer processor which is electrically connected to the monitor and the user interactive device; and
wherein the computer processor causes the monitor to display a menu of a plurality of television channel carriers and upon a user selecting a first carrier of the plurality of television signal carriers via the user interactive device, the computer processor enables the user to view the signal of that first carrier.

21. The apparatus of claim 20 further comprising
a means for receiving money; wherein the computer processor enables the user to view the signal of that first carrier only if a first amount of money is received by the means for receiving money.

22. The apparatus of claim 20 wherein
the means for receiving money includes a card/debit/prepaid card reader.

23. The apparatus of claim 20 wherein
the means for receiving money includes a currency bill validator.

24. A method comprising the steps of
displaying a menu of a plurality of television signal carriers;
receiving a user selection of a first carrier of the plurality of television signal carriers and enabling a user to view the signals of television signal carriers.

25. The method of claim 24 comprising the steps of
receiving money for a pay per use computer; and enabling the user to view the signal of the user selected television signal carrier from a menu of plurality of television signal carriers.

26. An apparatus comprising
a monitor;
a user interactive device;
and a computer processor which is electrically connected to the monitor and the user interactive device;
wherein the computer processor causes the monitor to display an option for the user to use the computer to play his game resident on his/her own game cartridge, which when selected causes the computer processor to test the game cartridge input port for the existence of a cartridge, and upon confirmation of such existence allows the user to play the games resident on the inserted cartridge.

27. The apparatus of claim 26 further comprising
a means for receiving money; wherein the computer processor enables the user to play the a game only if a first amount of money is received by the means for receiving money.

28. The apparatus of claim 27 wherein
the means for receiving money includes a credit/debit/prepaid card reader.

29. The apparatus of claim 27 wherein
the means for receiving money includes a currency bill validator.

30. A method comprising the steps of
displaying an option on a monitor for a user to use a computer to play a user's game resident on a user's game cartridge,
wherein when the option is selected a processor of the computer tests a game cartridge input port to determine if a game cartridge is connected to the game cartridge input port, and upon confirmation that the user's game cartridge is connected to the game cartridge input port, allows the user to play the games resident on the user's game cartridge.

31. The method of claim 30
wherein the computer is a pay per use computer; and further comprising
receiving money to pay for use of the computer;
and enabling the user to play the games resident on the user's game cartridge.

32. An apparatus comprising
a monitor;
a user interactive device;
and a computer processor which is electrically connected to the monitor and the user interactive device;
wherein the computer processor causes the monitor to display a menu of a plurality of parking lot/garage operators and upon a user selecting a first operator of the plurality of parking lot/garage operators via the user interactive device, the computer processor enables the user to insert a parking lot/garage ticket in the ticket reader slot, reads the ticket and charges him a fee for parking.

33. The apparatus of claim 32 further comprising
a means for receiving money electrically connected to the computer processor; and
wherein a user can pay for a parking lot/garage ticket through the means for receiving money.

34. The apparatus of claim 33 wherein
the means for receiving money includes a card/debit/prepaid card reader.

35. The apparatus of claim 33 wherein
the means for receiving money includes a currency bill validator.

36. A method comprising the steps of
displaying a menu of a plurality of parking lot/garage operators on a monitor;
receiving a user selection of a first parking lot/garage operator of the plurality of parking lot/garage operators and enabling a user to pay for a parking lot/garage ticket.

37. The method of claim 36 further comprising
receiving money to pay for the parking lot/garage ticket.

38. An apparatus comprising
a monitor;
a user interactive device;
and a computer processor which is electrically connected to the monitor and the user interactive device;
wherein the computer processor causes the monitor to display a menu of a plurality of games, plays, or movies, depending on the physical location of the monitor and upon a user selecting a particular game, play, or movie, of the plurality of games, plays, or movies via the user interactive device, the computer processor enables the user to purchase a ticket for the particular game, play, or movie.

39. The apparatus of claim 38 further comprising
a means for receiving money;
wherein the computer processor enables the user to purchase a ticket for the particular game, play, or movie when an amount of money is received by the means for receiving money.

40. A method comprising the steps of
displaying a menu of a plurality of games, plays, or movies;
receiving a user selection of a particular game, play or movie of the plurality of games, plays, or movies and enabling a user to pay for a ticket for particular game, play, or movie.

41. The method of claim 40 comprising the steps of
receiving money to pay for the particular game, play, or movie.

42. apparatus comprising
a monitor;
a user interactive device;
and a computer processor which is electrically connected to the monitor and the user interactive device; and
wherein the computer processor causes the monitor to display a menu of a plurality of lotteries depending on the physical location of the monitor and upon a user selecting a particular lottery of the plurality of lotteries via the user interactive device, the computer processor enables the user to purchase a ticket for the particular lottery.

43. The apparatus of claim 42 further comprising
a means for receiving money electrically connected to the computer processor;
wherein the computer processor enables the user to purchase a ticket for the particular lottery when an amount of money is received by the means for receiving money.

44. A method comprising the steps of
displaying a menu of a plurality of lotteries; and
receiving a user selection of a particular lottery of the plurality of lotteries and enabling a user to pay for a ticket for the user selected lottery.

45. The method of claim 44 comprising the steps of
receiving money to pay for the ticket to the user selected lottery.

46. An apparatus comprising
a monitor;
a user interactive device;
and a computer processor which is electrically connected to the monitor and the user interactive device;
wherein the computer processor causes the monitor to display a menu of a plurality of games/plays/movies depending on the physical location of the monitor. and upon a user selecting a game/play/movie of the plurality of games/plays/movies via the user interactive device, the computer processor enables the user to purchase tickets for the user selected game/play/movie.

47. The apparatus of claim 46 further comprising
a means for receiving money which is electrically connected to the computer processor;
wherein the computer processor enables the user to a purchase ticket for a user selected game, play, or movie when an amount of money is received by the means for receiving money.

48. An apparatus comprising
a monitor;
a user interactive device;
and a computer processor which is electrically connected to the monitor and the user interactive device;
wherein the computer processor causes the monitor to display a menu of a plurality of municipal, state, or federal levies, fines, or utility charges;
and upon a user selecting a choice of the plurality of municipal, state, or federal levies, fines, or utility charges via the user interactive device, the computer processor enables the user to pay for the charges.

49. The apparatus of claim 48 further comprising
a means for receiving money electrically connected to the computer processor;
wherein the computer processor enables the user to pay the charges when an amount of money is received by the means for receiving money.

50. A method comprising the steps of
displaying a menu of a plurality of municipal, state, or federal levies, fines, or utility charges;
receiving a user selection of a charge of the plurality of municipal, state and or Federal levies, fines, or utility charges, and enabling a user to pay for the charge.

51. The method of claim 50 comprising the steps of
receiving money to pay for the user's charge.

52. An apparatus comprising
a monitor;
a user interactive device;
and a computer processor which is electrically connected to the monitor and the user interactive device;
wherein the computer processor causes the monitor to display a menu of a plurality of video games, movies, music, or sound tracks;
and upon a user selecting a choice of the plurality of video games, movies, music, or sound tracks, via the user interactive device, the computer processor enables the user to record his choice onto a recording and playback media, after the user pays a charge through the means provided for payment of a charge, if a charge is levied.

53. The apparatus of claim 52 further comprising
a means for receiving money electrically connected to the computer processes wherein the computer processor enables the user to pay for the privilege of copying one or more of a plurality of video games, movies, music, or sound tracks, when an amount of money is received by the means for receiving money.

54. A method comprising the steps of
displaying a menu of a plurality video games, movies, music, or sound tracks;
receiving a user selection of a choice from the plurality of video games, movies, music, or sound tracks;
and enabling a user to pay for recording the choice onto any playback media.

55. The method of claim 54 comprising the steps of
receiving money to pay for the recording of the choice.
